(19) United States
(12) Patent Application Publication
(10) Pub. No.: US 2016/0086221 A1
(43) Pub. Date: Mar. 24, 2016

(54) PURCHASE INCENTIVE DELIVERY SYSTEM AND METHOD

(71) Applicant: Lee S. Weinblatt, TEANECK, NJ (US)

(72) Inventor: Lee S. Weinblatt, TEANECK, NJ (US)

(21) Appl. No.: 14/860,097

(22) Filed: Sep. 21, 2015

Related U.S. Application Data
(60) Provisional application No. 62/053,851, filed on Sep. 23, 2014.

(51) Int. Cl. G06Q 30/02; G06F 3/01; G06F 3/00; G06T 19/00

(52) U.S. Cl. CPC G06Q 30/0255; G06T 19/006; G06F 3/013; G06F 3/005

(57) ABSTRACT

A system and method for augmenting a consumers purchase decision by automatically collecting purchase incentive data and/or other product information and by having the incentives and other information automatically available to the consumer at the time of purchase. A mobile digital device, such as a tablet or smartphone, is enabled with an app for storing inaudible purchase incentive data and/or other product information embedded in selected broadcast content. The mobile digital device is paired with eye-tracking or close scene gazing glasses having a camera and recognition software for generating product identification data corresponding to the product image captured by the camera while the product is being viewed, in situ. If the product identification data is correlated to the stored purchase incentive data an alert will appear in the eye-tracking glasses and the consumer can then access the mobile digital device to save and/or download the purchase incentive data.

### RELATED APPLICATION

This application claims priority from U.S. Provisional Patent Application Ser. No. 62/053,851, filed on Sep. 23, 2014 the content of which is hereby incorporated herein by reference.

### BACKGROUND OF THE INVENTION

1. Field of the Invention

This invention relates generally to consumer purchase incentives and especially to the distribution of discount coupons, vouchers, and related promotional programs.

In particular, the purchase incentive delivery system of this invention concerns a method whereby purchase incentives are automatically collected and automatically communicated to a consumer at the precise moment in time when the purchasing consideration is being made.

2. Description of the Related Art

Traditionally, advertisers have relied upon TV, radio, online and product placement as marketing tools. Although these methods can inform the consumer about the existence of the product or can create a demand for a particular brand, or can create the desire to take immediate action, or can inform the audience about special deals such as discount pricing, nevertheless, these marketing techniques have significant drawbacks. For example, exposure to an advertisement rarely occurs at the same time as the opportunity to make a purchase; this may be critical since the desire for the advertised product can diminish over time. Additionally, the impact of an initial advertisement is reduced by subsequent exposure to competitive advertisements. Furthermore, the ability to reach a target audience is becoming more difficult because of the growth of media sources and content.

Since the purchase price is often a significant motivating factor in purchasing decisions, marketers frequently offer discount coupons or discounted pricing or provide a gift in exchange for the performance of an act, such as purchasing a good or service or use similar purchase incentives. These incentives are frequently in paper or “hard copy” form, such as a certificate on which is printed the terms of the discount offer and is often distributed in newspapers and magazines or by mail. A disadvantage of these paper coupons is that effective distribution is difficult due to the decrease in newspaper and magazine circulation and the relatively high cost of direct mail distribution. Another shortcoming of paper coupons is that that only a limited percentage of coupons are redeemed. A further limitation of paper coupon promotions is that many consumers do not use coupons when shopping for the reason that they often forget to bring them at the time of purchase or do not remember that the discount offers exists, or miss the expiration date for redemption. An additional problem with paper coupons is that some shoppers are simply not willing to expend the effort necessary to collect, collate, manage, and redeem the coupons.

Although there has been an increasing trend toward the utilization of the Internet to distribute digital coupons and similar online incentives, a majority of brands sold in supermarkets must rely on consumers to print digital coupons at home and bring them to the supermarket. Digitally printed coupons can be problematic for the reasons mentioned above with regard to paper coupons. There also exists the difficulty in targeting offers to online consumers who would be most likely to use the offers.

There are further limitations with digital coupons delivered to mobile devices for retrieval and redemption, such as shown in U.S. Pat. No. 7,555,444. The consumer using those devices must scan a bar code or other machine readable code on the product packaging in the store to bring up information about incentive offers. A drawback of this method is that consumers may find this to be a time-consuming inconvenience, especially if the bar code is not readily visible and/or accessible on the shelved product. Also the scanning is not simultaneous with the purchase making decision. Furthermore, in some systems, the shopper has to find and launch computer application software on their digital device to enable the bar-code reader.

Another method for providing consumers with purchase incentives uses electronically generated coupons as discussed in published patent application no. US 2003/0144035 A1. The consumer can make a real time selection of a coupon related to a product in a commercial being shown on television. A code transmitted with the commercial is converted to a coupon displayed on a portable unit that can be scanned by a merchant for redemption. A limitation of the purchase incentive of this system is that the coupon is not deliverable to the consumer at the point of sale.

### SUMMARY OF THE INVENTION

Briefly, this invention concerns a system and method for augmenting consumer purchase at point of sale by automatically providing the consumer with access to customized and desired marketing content, including purchase incentive data, such as discount coupons, vouchers, special offers, video commercials, sale pricing, etc. It should be understood that the terms “purchase incentive data” as used herein applies to any information that may influence a consumer in making a decision to purchase and can, for instance, be performance specifications as it relates to a motor vehicle being offered for sale; or a recipe using a food ingredient being promoted and, in short, is any information an advertiser believes will promote the sale of a product. It should also be noted that the consumer can filter the product categories of marketing content so as to limit the purchase incentive data received to match consumer pre-identified preferences.

The method of this invention involves the selective collecting of inaudible encoded purchase incentive data, embedded in audio streams of broadcast content, such as commercials, for delivery to a consumer's mobile digital device. The mobile digital device is loaded with an app for receiving and storing the encoded purchase incentives. The mobile device is paired to consumer wearable eye-tracking or close scene gazing glasses that includes a camera such that a in situ product on a retail store shelf, even if at a relative distance and among competing products, can be simultaneously viewed by the consumer and the camera. If the consumer has indicated potential preference in the product category, product package recognition software will generate product identification data correlated to the product image captured by the camera.

The mobile device searches the stored purchase incentive data for the generated product identification data and then retrieves and displays the current active corresponding purchase incentive data to the consumer at the moment of deciding whether or not to purchase from among the competing on-shelf products. The purchase incentive data can, for instance, be in the form of a coupon displayed on the mobile device screen and used for check-out scanning when the sale is made.

Having thus described the invention it will be seen that it is a feature thereof to provide a purchase incentive delivery system and method that is not subject to the aforementioned disadvantages, shortcomings and limitations.

A further feature of this invention is to deliver purchase incentive data within a selected product category to a consumer at the precise moment of purchase.

Another feature of this invention is to deliver purchase incentive data to a consumer without the need to a scan a product barcode.

A still further feature of this invention is to deliver purchase incentive data to a consumer in a hands-free format.

Yet another feature of this invention is to deliver purchase incentive data to a consumer based upon consumer customized and desired categories of marketing content so as to reach a more selective audience.

With these ends in view, the invention finds embodiment in certain combinations of elements and series of steps by which the aforementioned features and certain other features are herein attained, all as more fully described with reference to the accompanying drawings and the scope of which is more particularly pointed our herein.

### BRIEF DESCRIPTION OF THE DRAWINGS

In the accompanying drawings, in which are shown an exemplary embodiment of the invention:

FIG. 1 is a schematized illustration showing the components of a purchase incentive delivery system and method in accordance with this invention; and

FIG. 2 is a flow chart showing the steps involved in the purchase incentive delivery system and method of this invention.

### DETAILED DESCRIPTION OF THE INVENTION

With specific reference now to the drawings, it is stressed that the particulars shown are by way of example and for the purposes of illustrative discussion of the present invention and is presented in the cause of providing what is believed to be the most useful and readily understood description of the principles and conceptual aspects of the invention. In this regard no attempt has been made to show aspects of the invention in more detail than is necessary for a fundamental understanding of the invention. The description when taken together with the drawings should make apparent to those skilled in the art how the invention may be embodied in practice.

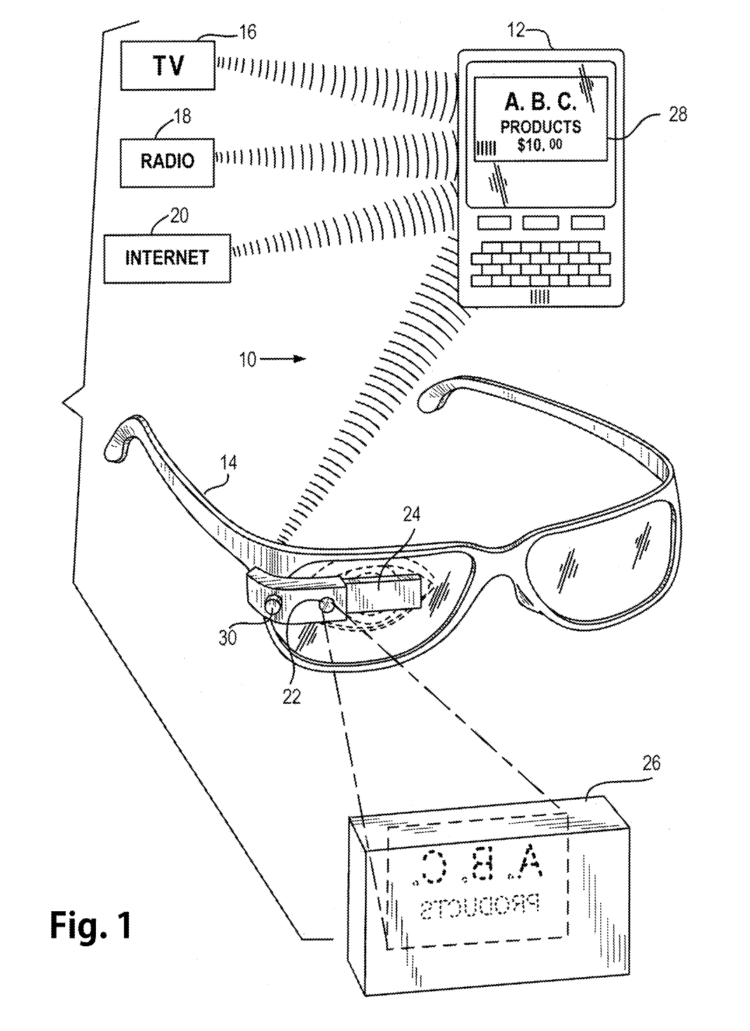

Referring now to FIG. 1 of the drawings, there is shown a purchase incentive delivery system and method 10 in accordance with this invention. The purchase incentive delivery system and method 10, includes a mobile digital device 12, and a wearable eye-tracking or close scene gazing glasses 14. The mobile digital device 12, is typically a mobile phone, a portable media player, a personal digital assistant, a handheld or tablet computer, a “smart” watch (e.g. APPLE WATCH®) or an equivalent digital device. For the purposes of this illustrative embodiment, the mobile digital device 12 is shown as a smartphone in FIG. 1. The mobile digital device 12, is loaded with computer application software (app) that is capable of receiving inaudible purchase incentive data that is embedded in audio signals of encoded broadcast content such as commercials, and/or other data. The content can typically originate from various broadcast sources, such as a television source 16, a radio source 18, or an Internet source 20, as illustrated in FIG. 1. The inaudible data is detected by a microphone or equivalent detecting element, in the mobile digital device 12. Further by way of example, an app such as MYCODE® described at www.mycodeapp.com. (or CODI® App), is designed to provide consumers with content, information, promotions, contests and discounts on products, in real-time, while consumers are experiencing advertisements for the product. The MYCODE® App is discussed in U.S. Pat. Nos. 8,805,682 and 8,555,305, and is incorporated herein by reference. With regard to the marketing content, the consumer can exclusively choose desired content from fields such as sports, fashion, cooking, and other categories that cater to the consumers' desires.

The television source 16, or the radio source 18, or the Internet source 20, is initially encoded with MYCODE®, or similar application software so as to automatically deliver exclusive content, videos, and coupons, downloads and offers to any MYCODE® or similar application software enabled mobile digital device 12 and store them in the app for use at any time. The app works automatically in the background utilizing the smartphone audio setting thus, giving the user a hands-free method of gaining information.

Referring once again to FIG. 1 the mobile device 12 is linked to the glasses 14 that incorporates a camera 22 having product recognition software. By way of example, the glasses 14 may be similar to the optical head mounted display known as GOOGLE GLASS®.

In accordance with the invention, a consumer, wearing the glasses 14, gazes in real-time, at a product 26 that may, for example, be on a retail store shelf among competition products. An image of the product 26, will be simultaneously captured by the camera 22. The image will be generated into product identification data by the product recognition software and wirelessly transmitted to the mobile digital device 12, for example, by BLUETOOTH® connection. Alternatively the app in the mobile device 12, may contain the product recognition software for generating the product identification data necessary to determine if the product 26 corresponds to any stored purchase incentive data. Also in lieu of the camera 22 in the glasses 14, a consumer may alternatively use a camera contained within the mobile device 12 for capturing an image of the product 26.

If a match is found an alert pops up on an eyeglass screen 24. The consumer will be able to elect to save the relevant purchase incentive data in an app folder. A consumer can thus shop for items and have corresponding purchase incentives stored in the app folder to later appear on the mobile device 12 as a coupon image 28 for scanning at the time of check-out. Consumers thereby gain information, coupons, articles, videos, and other information without having to look for it.

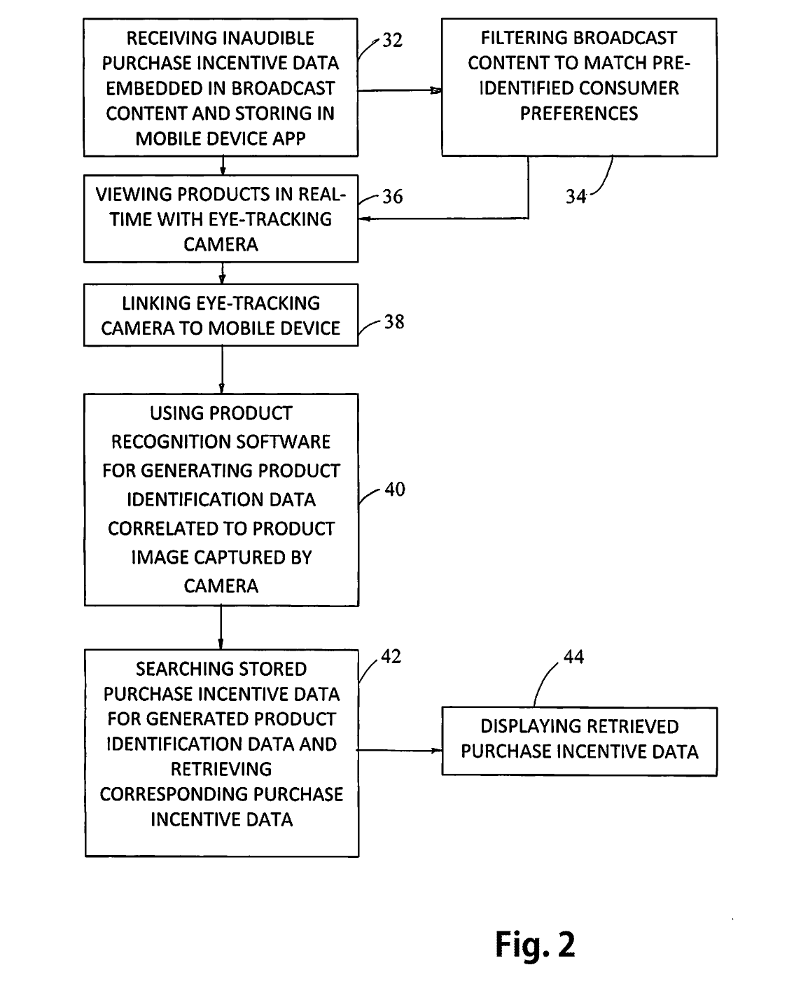

Referring now to FIG. 2 there is shown a flow chart diagrammatically illustrating the salient steps of the purchase delivery system and method of this invention. The initial step is the receiving of the inaudible purchase incentive data embedded in broadcast content and storing the incentive data in the app enabled mobile digital device as indicated at 32. A consumer may optionally filter categories of broadcast content to pre-identified preferences as shown at 34. The next step is the consumer viewing of products tracked in real time using an eye-tracking or close scene gazing glasses having a camera as denoted at 36. The camera is wirelessly linked to the mobile device as noted at 38. Product recognition software generates product identification data corresponding to the image captured by the camera as indicated at 40. The mobile device app then searches the stored purchase incentive data for the product identification data to retrieve corresponding purchase incentive data; this is described at 42. The retrieved purchase incentive data is then displayed, as noted at 44, to the consumer who may elect to file the incentive data in an app folder or to generate the coupon 28 for redemption.

In an exemplary mode of operation, a consumer would:

(1) Gaze at the on-shelf product 26 within the product category of interest for a fixed amount of time while wearing the glasses 14;

(2) Actuate the button 30 to ascertain if there is any purchase incentive data associated with the product 26;

(3) View an alert that will appear on the eyeglass screen 24 or on the “smart” watch or the smartphone if there is any purchase incentive data available;

(4) Actuate the button 30 to request the available data;

(5) Again actuate the button 30 to save the available data in an app file or download the data to the smartphone wherein the coupon 28 may be scanned for redemption.

In view of the foregoing, it should now be apparent that there is provided a method which achieves the various preferred objects of this invention and which is well adapted to meet conditions of practical use. Since other various possible variations might be made of the present invention or modifications might be made in the exemplary method set forth and described herein, it is to be understood that all of the above are to be interpreted in an illustrative sense and not in a limiting sense.

Having thus described the invention, there is claimed as new and desired to be secured by Letters Patent:

1. A purchase incentive delivery system and method comprising the steps of exposing a consumer to media broadcast content embedded with encoded purchase incentive data, enabling the consumer's mobile digital device with an app for receiving and storing the encoded purchase incentive data, linking the mobile digital device to a camera for tracking the consumer's viewing of selected products, generating product identification data correlated to the products viewed, searching the stored purchase incentive data for the generated product identification data, retrieving corresponding purchase incentive data, and sending an alert to the consumer if purchase incentive data is available for the product.

2. A purchase incentive delivery system and method as claimed in claim 1 further including the step of saving the retrieved purchase incentive data in an app file.

3. A purchase incentive delivery system and method as claimed in claim 2 further including the step of downloading the saved purchase incentive data for visual display on the mobile digital device.

4. A purchase incentive delivery system and method as claimed in claim I wherein the purchase incentive data is transmitted in an inaudible code.

5. A purchase incentive delivery system and method as claimed in claim 1 wherein the broadcast content is sourced through at least one of a television, a radio and an Internet.

6. A purchase incentive delivery system and method as claimed in claim 1 wherein the mobile digital device is linked to the camera for simultaneous transmission of the viewed image.

7. A purchase incentive delivery system and method as claimed in claim 1 wherein the product identification data is generated by recognition software in at least one of the camera and the mobile digital device.

8. A purchase incentive delivery system and method as claimed in claim 1 wherein the broadcast content is selectively filtered to match the consumer's pre-identified preferences.

9. A purchase incentive delivery system and method as claimed in claim 1 wherein the camera is remotely located with respect to the mobile digital device.

10. A purchase incentive delivery system and method as claimed in claim 1 wherein the application software in the mobile digital device runs continuously in the background.

11. A purchase incentive delivery system and method as claimed is claim 1 wherein the camera is incorporated within at least one of an eye-tracking and a close scene gazing glasses.

12. A purchase incentive delivery system and method as claimed in claim 1 wherein the camera is contained within consumer wearable eyeglasses.

13. A purchase incentive delivery system and method as claimed in claim 12 wherein the consumer is alerted to the availability of purchase incentive data by a display appearing in the eyeglasses.

14. A purchase incentive delivery system and method comprising broadcasting subject matter content having embedded therein encoded affiliated data associated with the subject matter, enabling a mobile digital device with application software for capturing and storing the affiliated data, linking the mobile digital device to a camera, simultaneously transmitting images of the subject matter viewed by the camera to the mobile digital device, using recognition software for generating subject matter identification data correlated to the subject matter viewed; comparing the identification data with the stored affiliated data, and retrieving the affiliated data associated with corresponding subject matter.

15. A purchase incentive delivery system and method of claim 14 further including downloading the affiliated data associated with the subject matter for display on the mobile digital device.

16. A purchase incentive delivery system of and method of claim 14 wherein the camera source is contained within a wearable eye-tracking glasses.

17. A purchase incentive delivery system and method of claim 14 wherein the recognition software is in at least one of the camera and the mobile digital device.

18. A purchase incentive delivery system and method of claim 14 wherein the affiliated data provides amplification of the subject matter.

19. A purchase incentive delivery system and method of claim 14 wherein the application software in the mobile digital device runs continuously in the background.

20. A purchase incentive delivery system and method of clam 14 wherein the affiliated data is encoded with an inaudible code.
